(19) United States
(12) Patent Application Publication
(10) Pub. No.: US 2006/0177809 A1
(43) Pub. Date: Aug. 10, 2006

(54) Searching game

(76) Inventors: Jeff A. Rich, Sherwood, OR (US); Carolyn J. Rich, Sherwood, OR (US)

Correspondence Address: Thompson E. Fehr;Suite 300, Goldenwest Corporate Center, 5025 Adams Avenue, Ogden, UT, 84403, US

(21) Appl. No.: 11/054,516

(22) Filed: Feb. 8, 2005

(51) Int. Cl. G09B 25/00

(52) U.S. Cl. 434/365

(57) ABSTRACT

A searching game utilizing a bag having a window and containing physical objects together with filler. A means is included for determining for which object a participant should search. The determining means can be a flash card or an electronic storage medium to be used in conjunction with a player. The object is displayed, and one searches for it by manipulating the bag until the desired object is visible through the window. Preferably, after all the objects have been located, the determining means establishes a different order for locating the objects. In one particular embodiment, each physical object shows a number that is different from the number shown by any other physical object and is the answer to a mathematical problem which is displayed.

### BACKGROUND OF THE INVENTION

1. Field of the Invention

This invention relates to a game involving a bean bag having a bag with a window, so that a search can be conducting by viewing the contents of the bag, as well as a device for guiding the search.

2. Description of the Related Art

A bean bag having a bag with a window, preferably a flexible window, and containing physical objects in addition to filler material which allows the physical objects to be moved within the bag by manipulating the bag has been known and publicly used for more than one year. (For the purposes of this patent application, the term “bean bag” is used to designate a bag containing filler material, with or without other items; the term “bag” standing alone refers to the flexible type of container that is traditionally termed a “bag.”) Also known and publicly used for this time is a card containing a list of the physical objects.

The inventors are, however, unaware that a list of the physical objects within the bag has ever been printed on the bag.

Nor have the inventors ever learned of any game involving the bean bag containing the physical objects in addition to filler material. As far as they know, the bean bag with the physical objects in addition to filler material has just be used as a toy for children to use to amuse themselves, especially in environments where it is desirable to have a child be quiet, such as during a church meeting.

### BRIEF SUMMARY OF THE INVENTION

The present invention, in one embodiment, has printed on a bag with a window the identification of the physical objections, other than the filler, which are contained within the bag.

Most significantly, however, the present invention shows items other than the filler material contained within the bag which a child is to locate by manipulating the bag to move the physical objects contained within the bag until the object being sought can be viewed through the window of the bag. In one embodiment the object to be sought is shown on a flash card. In another embodiment an electronic storage medium, such as a DVD or CDROM, is used with a player to display the object to be sought.

The physical objects, in one embodiment, are any objects with which a child would be familiar and which would interest a child. In another embodiment each of the physical objects contains the outline of a particular state unique from the outline of any other state. And in still another embodiment each of the objects shows a particular number that is different from the number of any other object within the bag; in this embodiment a mathematical problem is shown so that the child or other participant can search for the object in the bag indicating that number. Preferably, the answer to the mathematical problem is displayed after a period of time so that the participant can know whether he or she successfully solved the problem.

### BRIEF DESCRIPTION OF THE SEVERAL VIEWS OF THE DRAWING

FIG. 1 portrays a bean bag comprising a bag having a window filled with physical objects and filler material.

FIG. 2 exhibits, printed on the bag, a bean bag with a list of the physical objects other than filler material contained within the bag.

FIG. 3 shows a DVD or CDROM.

FIG. 4 portrays a flash card having on it a portrayal of one of the physical objects other than filler material that is contained with the bag of the bean bag.

FIG. 5 depicts a first side of a flash card containing a mathematical problem.

FIG. 6 illustrates a second side of the flash card shown in FIG. 4 with the answer, on such second side, to the mathematical problem shown on the first side.

### DETAILED DESCRIPTION OF THE INVENTION

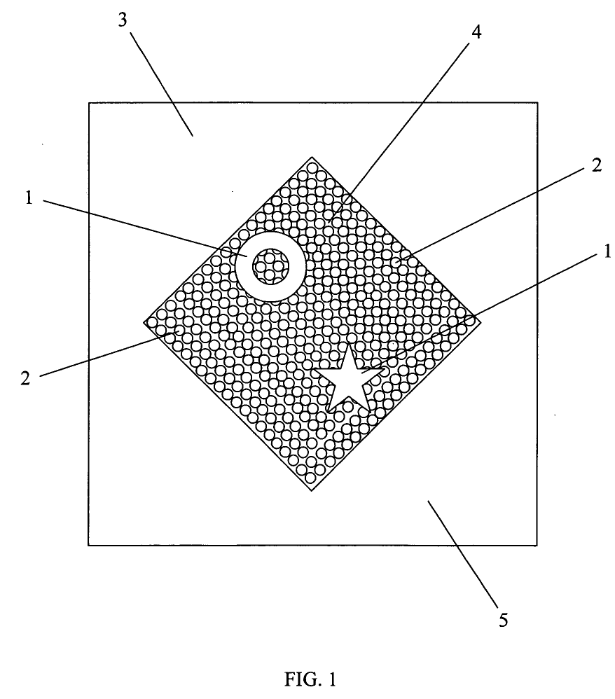

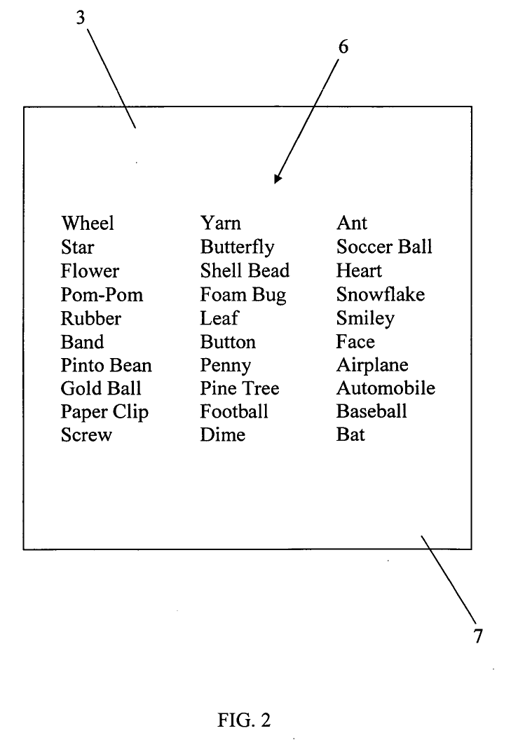

The physical components of the Searching Game of the present invention comprise, as depicted in FIG. 1, physical objects 1 placed, together with filler material 2 which is preferably poly pellets, within a bag 3 having a window 4 which is preferably flexible. (Although the window 4 is shown of the front 5 of the bag 3 in FIG. 1, the window can be located anywhere on the bag 3.) The physical components further comprise a means for determining a physical object 1 to be located within the bag 3 by manipulating the bag 3 until the desired physical object 1 is visible through the window 4. Optionally, the bag 3 has more than one window. And, preferably, a list 6 of the physical objects 1 contained within the bag is, as shown in FIG. 2, printed on the bag 3, preferably on the rear 7 of the bag 3.

The physical objects 1 are any physical item which can safely be moved within a bag 3. In a first embodiment, the physical objects 1 with which a child would be familiar and which would interest a chilled. In another embodiment, as discussed above, each of the physical objects 1 contains the outline of a particular state of the United States unique from the outline of any other state; for example, the object may be in the shape of the state or have the outline of the state placed upon it through any means that is well known in the art, such as printing. And in still another embodiment, also mentioned above, each of the objects 1 shows a particular number that is different from the number shown by any other object 1 within the bag 3; in this embodiment a mathematical problem 8 is shown so that a child or other participant can search for the object 1 in the bag indicating the number that is the answer 9 to the mathematical problem 8. Preferably, as noted above, the answer 9 to the mathematical problem 8 is displayed after a period of time so that the participant can know whether he or she successfully solved the problem.

Optionally, the physical objects 1 are selected from objects oriented toward a particular theme, e.g., a holiday, such as Valentine's day, Easter, or Christmas.

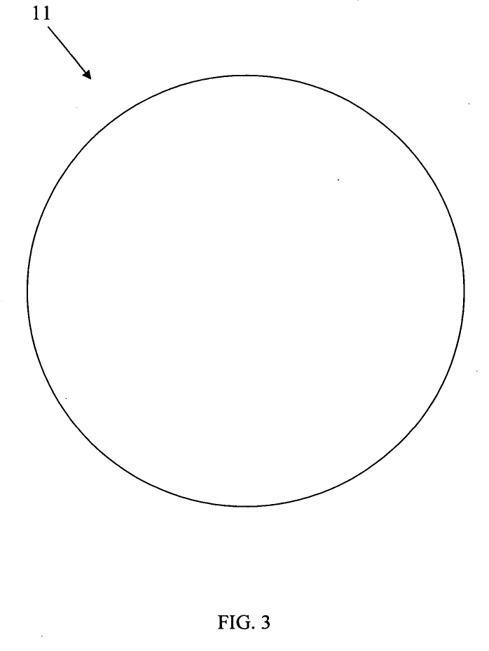

The means for determining a physical object 1 to be located within the bag 3 is either a flash card 10 or an electronic storage medium 11, such as a DVD or CDROM, as portrayed in FIG. 3, to be used with a player for displaying a physical object. When an electronic storage medium 11 is utilized with a player, the electronic storage medium can either contain instructions which will cause the display to change to another physical object 1 after a fixed time or a time set by one using the electronic storage medium 11 or may have instructions that will cause the display to change to another physical object 1 when a particular action is taken with respect to the player, e.g., pressing a particular button; these options can be characterized by saying that the electronic storage medium 11 contains instructions for causing the player periodically to change the physical object 1 that is displayed.

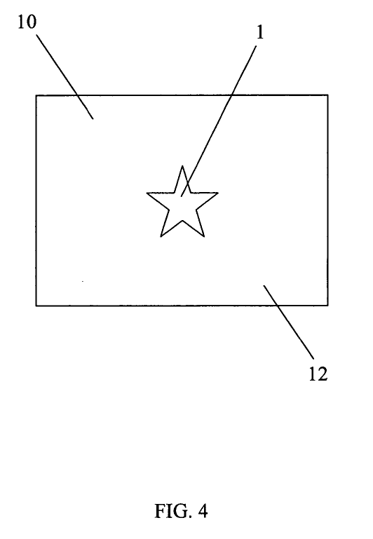

When a flash card 10 is utilized, the physical object 1 for which a participant is to search is portrayed on a first side 12 of the flash card 10, as shown in FIG. 4. In one embodiment, only a single physical object 1 is portrayed on the first side 12 of the flash card 10. In another embodiment, more than one physical object 1 is portrayed on the first side 12 of the flash card 10.

One version of the game will, when a flash card 10 portrays more than one physical object 1, specify the particular order in which a participant is to locate each portrayed physical object 1. Another version will, when a flash card 10 displays more than one physical object 1, allow the participant to locate the displayed physical objects 1 in any order. These different versions of the game exist also, of course, when the physical objects 1 are displayed by using an electronic storage medium 11 with a player.

Of course, when flash cards 10 are utilized, a person simply displays a first flash card 10; searching for the object occurs; an answer 9 is preferably shown if the flash card 10 portrays a mathematical problem 8; and, after a desired time interval, another flash card 10 is displayed. The process then continues in this fashion.

Preferably, the electronic storage medium 11 contains instructions that will cause a player in conjunction with which the electronic storage medium 11 is utilized, to display the physical objects 1 in a different order after all physical objects 1 have been displayed during a continuous period of operation of the electronic storage medium 11 in conjunction with a the player. With flash cards 10 this can also be done, e.g, by shuffling the flash cards 10.

Optionally, rather than actually displaying a physical object 1, a flash card 10 may simply contain the printed name of the physical object 1; and an electronic storage medium 11 may contain instructions to cause a player in which such electronic storage medium 11 is operated simply to display the printed name of the physical object 1. The term “portraying” shall herein include any of the following: a picture portrayal, a printed name, or a displayed name.

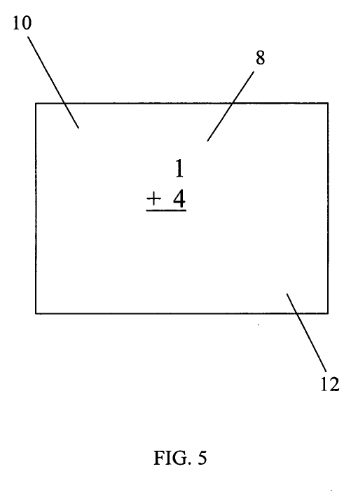

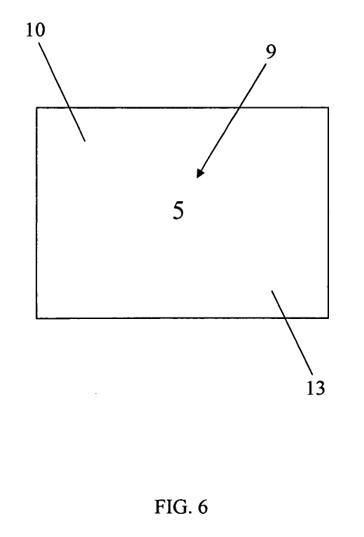

When a flash card 10 contains a mathematical problem 8 on a first side 12, as illustrated in FIG. 5, preferably, as implied above, the flash card 10 shows the answer 9 to the mathematical problem on a second side 13 of the flash card 10, as portrayed in FIG. 6. Also preferably, when an electronic storage medium 11 contains instructions to cause a player in which the electronic storage medium 11 is operated to display a mathematical problem 8, preferably the electronic storage medium 11 also contains instructions to cause the player to display the answer 9 to the mathematical problem 8. And preferably, using either the flash card 10 or the electronic storage medium 11, the display of the answer 9 will be delayed for a desired period of time after the problem has been displayed.

In the preferred case discussed in the preceding paragraph, for an electronic storage medium 11 utilized with a player, the electronic storage medium can either contain instructions which will cause the display to change from a mathematical problem 8 to the answer 1 for that problem 8 after a fixed time or a time set by one using the electronic storage medium 11 or may have instructions that will cause the display to change from a mathematical problem 8 to the answer 1 for that problem 8 when a particular action is taken with respect to the player, e.g., pressing a particular button; these options can be characterized by saying that the electronic storage medium 11 contains instructions for causing the player periodically to change the display from a mathematical problem 8 to the answer 1 for that problem 8. Such display of the answer 1 occurs, according to the instructions contained by the electronic storage medium 11, before the instructions contained by the electronic storage medium 11 cause the player to change the display from a first mathematical problem 8 to another mathematical problem 8, as described above for physical objects 1 in general but, of course, being equally applicable to changing from a first mathematical problem 8 to another mathematical problem 8 and proceeding similarly for each subsequent mathematical problem 8.

As is the case with physical objects 1, the flash card 10 or player instructed by the electronic storage medium 11 may display only a single mathematical problem 8 or more than one mathematical problem 8 and may either direct that the answers 9 to such mathematical problems 8 be located in a specified order or allow the participant to locate the answers 9 to the displayed mathematical problems in any order.

Of course, also as with the physical objects 1, preferably, the electronic storage medium 11 contains instructions that will cause a player in which the electronic storage medium 11 has been placed, to display the mathematical problems 8 in a different order after all the mathematical problems 8 contained on the electronic storage medium 11 have been displayed during a continuous period of operation of the electronic storage medium 11 in conjunction with the player.

And any version of the game may continue to be played as long as a participant desires.

As used herein, the term “preferable” or “preferably” means that a specified element or technique is more acceptable than another but not that such specified element or technique is a necessity.

We claim:

1. A searching game, which comprises:
a bag having a window and containing physical objects together with filler and having printed on the bag a list of the physical objects.

2. A searching game, which comprises:
a bag having a window and containing physical objects together with filler.

3. The searching game as recited in claim 2, further comprising:
a means for determining a physical object to be located within said bag by manipulating said bag until such physical object is visible through the window of said bag.

4. The searching game as recited in claim 3, wherein:
said means for determining comprises a flash card having only a single physical object portrayed on a first side of the flash card.

5. The searching game as recited in claim 3, wherein:
said means for determining comprises a flash card portraying, on a first side of the flash card, two or more physical objects and not stating any particular order in which such physical objects are to be located.

6. The searching game as recited in claim 3, wherein:
said means for determining comprises a flash card portraying, on a first side of the flash card, two or more physical objects and specifying a particular order in which such physical objects are to be located.

7. The searching game as recited in claim 3, wherein:
each of the physical objects contains the outline of a particular state of the United States unique from the outline of any other state; and
said means for determining comprises a flash card portraying, on a first side of the flash card, the outline of a single state of the United States.

8. The searching game as recited in claim 3, wherein:
each of the physical objects contains the outline of a particular state of the United States unique from the outline of any other state; and
said means for determining comprises a flash card portraying, on a first side of the flash card, the outlines of two or more states of the United States and not stating any particular order in which such outlines are to be located.

9. The searching game as recited in claim 3, wherein:
each of the physical objects contains the outline of a particular state of the United States unique from the outline of any other state; and
said means for determining comprises a flash card portraying, on a first side of the flash card, the outlines of two or more states of the United States and specifying a particular order in which such outlines are to be located.

10. The searching game as recited in claim 3, wherein:
each of the physical objects shows a particular number that is different from the number shown by any other physical object; and
said means for determining comprises a flash card portraying, on a first side of the flash card, a mathematical problem the solution to which is a number shown by one of the physical objects.

11. The searching game as recited in claim 3, wherein:
each of the physical objects shows a particular number that is different from the number shown by any other physical object; and
said means for determining comprises a flash card portraying, on a first side of the flash card, two or more mathematical problems with the solutions to such problems being numbers shown by two or more of the physical objects and not stating any particular order in which such numbers are to be located.

12. The searching game as recited in claim 3, wherein:
each of the physical objects shows a particular number that is different from the number shown by any other physical object; and
said means for determining comprises a flash card portraying, on a first side of the flash card, two or more mathematical problems with the solutions to such problems being numbers shown by two or more of the physical objects and not specifying a particular order in which such numbers are to be located.

13. The searching game as recited in claim 3, wherein:
said means for determining comprises an electronic storage medium to be used with a player for portraying one of the physical objects, said electronic storage medium containing instructions for causing the player periodically to change the physical object that is portrayed.

14. The searching game as recited in claim 13, wherein:
each of the physical objects contains the outline of a particular state of the United States unique from the outline of any other state.

15. The searching game as recited in claim 13, wherein:
said electronic storage medium is selected from the group consisting of DVD's and CDROM's.

16. The searching game as recited in claim 15, wherein:
each of the physical objects contains the outline of a particular state of the United States unique from the outline of any other state.

17. The searching game as recited in claim 15, wherein:
said electronic storage medium also contains instructions that will cause a player in conjunction with which said electronic storage medium is utilized, to portray the physical objects in a different order after all physical objects have been portrayed during a continuous period of operation of said electronic storage medium in conjunction with the player.

18. The searching game as recited in claim 17, wherein:
each of the physical objects contains the outline of a particular state of the United States unique from the outline of any other state.

19. The searching game as recited in claim 13, wherein:
said electronic storage medium also contains instructions that will cause a player in conjunction with which said electronic storage medium is utilized, to portray the physical objects in a different order after all physical objects have been portrayed during a continuous period of operation of said electronic storage medium in conjunction with the player.

20. The searching game as recited in claim 19, wherein:
each of the physical objects contains the outline of a particular state of the United States unique from the outline of any other state.

21. The searching game as recited in claim 3, wherein:
each of the physical objects shows a particular number that is different from the number shown by any other physical object; and
said means for determining comprises an electronic storage medium to be used with a player for portraying a first mathematical problem the solution to which is a number shown by one of the physical objects, said electronic storage medium containing instructions for causing the player periodically to change the mathematical problem that is portrayed to another mathematical problem the solution to which is a number shown by another one of the physical objects.

22. The searching game as recited in claim 21, wherein:
said electronic storage medium is selected from the group consisting of DVD's and CDROM's.

23. The searching game as recited in claim 22, wherein:
said electronic storage medium also contains instructions that will cause a player in conjunction with which said electronic storage medium is utilized, to portray the mathematical problems in a different order after all the mathematical problems on said electronic storage medium have been portrayed during a continuous period of operation of said electronic storage medium in conjunction with the player.

24. The searching game as recited in claim 21, wherein:
said electronic storage medium also contains instructions that will cause a player in conjunction with which said electronic storage medium is utilized, to portray the mathematical problems in a different order after all the mathematical problems on said electronic storage medium have been portrayed during a continuous period of operation of said electronic storage medium in conjunction with the player.

25. The searching game as recited in claim 3, wherein:
each of the physical objects shows a particular number that is different from the number shown by any other physical object; and
said means for determining comprises an electronic storage medium to be used with a player for portraying a first mathematical problem the solution to which is a number shown by one of the physical objects, said electronic storage medium containing instructions for causing the player periodically to change from portraying the first mathematical problem to portraying the answer for such first mathematical problem and then periodically to change the mathematical problem and subsequently the related answer that is portrayed to another mathematical problem the solution to which is a number shown by another one of the physical objects and to such other related answer.

26. The searching game as recited in claim 25, wherein:
said electronic storage medium is selected from the group consisting of DVD's and CDROM's.

27. The searching game as recited in claim 26, wherein:
said electronic storage medium also contains instructions that will cause a player in conjunction with which said electronic storage medium is utilized, to portray the mathematical problems in a different order after all the mathematical problems on said electronic storage medium have been portrayed during a continuous period of operation of said electronic storage medium in conjunction with the player.

28. The searching game as recited in claim 25, wherein:
said electronic storage medium also contains instructions that will cause a player in conjunction with which said electronic storage medium is utilized, to portray the mathematical problems in a different order after all the mathematical problems on said electronic storage medium have been portrayed during a continuous period of operation of said electronic storage medium in conjunction with the player.

29. A searching game, which comprises:
portraying a physical object which is contained within a bag having a window and containing physical objects together with filler; and
subsequently searching for the physical object that has been portrayed.

30. The searching game as recited in claim 29, wherein:
each of the physical objects contains the outline of a particular state of the United States unique from the outline of any other state.

31. The searching game as recited in claim 29, further comprising:
after a desired time interval, portraying another physical object.

32. The searching game as recited in claim 31, wherein:
each of the physical objects contains the outline of a particular state of the United States unique from the outline of any other state.

33. A searching game, which comprises:
portraying two or more physical object which are contained within a bag having a window and containing physical objects together with filler without specifying any order for locating such physical objects; and
subsequently searching for the physical objects that have been portrayed.

34. The searching game as recited in claim 33, wherein:
each of the physical objects contains the outline of a particular state of the United States unique from the outline of any other state.

35. A searching game, which comprises:
portraying two or more physical object which are contained within a bag having a window and containing physical objects together with filler;
specifying a particular order for locating such physical objects; and
subsequently searching, in the order specified, for the physical objects that have been portrayed.

36. The searching game as recited in claim 35, wherein:
each of the physical objects contains the outline of a particular state of the United States unique from the outline of any other state.

37. A searching game, which comprises:
portraying a mathematical problem the answer to which is a number shown by a physical object which is contained within a bag having a window and containing physical objects, each such physical object showing a particular number that is different from the number shown by any other physical object, together with filler;
determining the answer to the mathematical problem that has been portrayed; and
searching for the physical object showing the number that is the answer to the mathematical problem that has been portrayed.

38. The searching game as recited in claim 37, further comprising:
periodically changing the mathematical problem that is portrayed to another mathematical problem the solution to which is a number shown by another one of the physical objects;
determining the answer to the changed mathematical problem; and
searching for the physical object showing the number that is the answer to the changed mathematical problem.

39. The searching game as recited in claim 37, further comprising:
after the mathematical problem has been portrayed, portraying the answer to the mathematical problem.

40. The searching game as recited in claim 39, further comprising:
After the answer to the mathematical problem has been portrayed, periodically changing the mathematical problem that is portrayed to another mathematical problem the solution to which is a number shown by another one of the physical objects;
determining the answer to the changed mathematical problem; and
searching for the physical object showing the number that is the answer to the changed mathematical problem.
